(19) United States
(12) Patent Application Publication
(10) Pub. No.: US 2004/0090452 A1
(43) Pub. Date: May 13, 2004

(54) One-click recording

(76) Inventor: Mark H. Schmidt, West Islip, NY (US)

Correspondence Address: FROMMER LAWRENCE & HAUG, 745 FIFTH AVENUE- 10TH FL., NEW YORK, NY, 10151, US

(21) Appl. No.: 10/293,132

(22) Filed: Nov. 13, 2002

(51) Int. Cl. G09G 5/00

(52) U.S. Cl. 345/716

(57) ABSTRACT

A system and method for implementing highly efficient recording on computers. To generate a computer-based sound recording a user merely executes a single button-push/keystroke. For example, the user moves a mouse pointer to a screen icon or graphical user interface button and clicks. Sound will be recorded for the period in which the mouse button is in the “down” position. Thus, sound is recorded from the moment the mouse button is moved to the “down” position to the moment it is returned to the “up” position. The recording is automatically stored in a predetermined location so that the user does not have to specify a storage location.

### FIELD OF THE INVENTION

The present invention is directed toward computer generated recordings, and more particularly, toward a user friendly system and method for making computer generated recordings.

### BACKGROUND OF THE INVENTION

Prior techniques of generating sound recordings through the use of a computer involve several steps. For example, to make one sound recording using the Microsoft Windows XP Sound Recorder, a user must perform the following steps: (1) move mouse pointer to “Start” and click (2) move mouse pointer to “All Programs” (3) move pointer to “Accessories” (4) move pointer to “Entertainment” (5) move pointer to “Sound Recorder” and click (6) move pointer to “Record” and click to start recording (7) move pointer to “Stop” and click to stop recording (8) move pointer to “File” (9) move pointer to “Save As” and click (10) type in file name (note: this is a minimum 1 it may be necessary to set a path for the location of the file, and (11) move pointer to “Save” and click. To make a second sound recording, steps (1)-(11) must be repeated.

To play back a sound recording using the

Windows XP Sound Recorder, a user must (1) locate the recorded file, and (2) double click on the file to play. To play back a multiple of recorded files, the user must repeat these two steps for each recording.

Another available software product for recording sound is the nFinity QuickVoice software. However, the QuickVoice software also requires a user to execute a multiple of operations to generate a recording.

### SUMMARY OF THE INVENTION

The inventors of the present invention have recognized that more users will employ their computer's recording capability if it were easier to use. In particular, the inventors have recognized that a more efficient sound recorder would greatly enhance users' experience with such computer applications as e-mail, speech recognition and near-real-time record-keeping.

Accordingly, the present invention provides a system and method for implementing highly efficient recording on computers. To generate a computer-based recording with the invention a user performs a minimal number of button-pushes/keystrokes, and in preferred implementations only one push/keystroke.

In one implementation, the user moves a pointer of a computer mouse to a screen icon or to a “record button” of a graphical user interface and depresses the left-hand mouse button. Sound will be recorded for the period in which the mouse button is in the “down” position. That is, sound is recorded from the moment the mouse button is moved to the “down” position to the moment it is returned to the “up” position. The recording is automatically stored in a predetermined location so that the user does not have to specify a storage location.

In another implementation, the user moves the mouse pointer to a “record button” of a graphical user interface and “clicks” to begin recording. The user moves the pointer to a “stop button” of the interface and clicks to stop recording. Sound is continuously recorded for the period between clicking of the record button and clicking of the stop button. The recording is automatically stored in a predetermined location so that the user does not have to specify a storage location.

Thus, a user of the present invention can make computer generated recordings by executing a single operation and is relieved of the burden of having to execute multiple operations as required in prior art systems.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like-elements and parts, in which:

FIG. 1 shows a screen shot of the Microsoft Windows XP desktop in accordance with one embodiment of the invention;

FIG. 2A shows the pop-up menu that appears when the “Andrea” icon of FIG. 1 is right-clicked;

FIG. 2B shows the pop-up menu that appears when “Folders” is selected from the menu of FIG. 2A;

FIG. 2C shows the pop-up menu that appears when “Show on Desktop” is selected from the menu of FIG. 2B;

FIG. 3 shows an example of how the display of FIG. 1 is enhanced when a recording is being played back;

FIG. 4 shows the pop-up menu that appears when one of the icons of the invention is right-clicked during playback of a recording;

FIG. 5 shows a screen shot of a graphical user interface in accordance with a second embodiment of the invention;

FIG. 6 shows the graphical user interface of FIG. 5 in expanded form;

FIG. 7 shows the graphical user interface of FIG. 5 as it appears during sound recording;

FIG. 8 shows a pop-up menu for use in erasing sound recordings in accordance with the invention;

FIG. 9 shows a preferences pop-up menu in accordance with the invention;

FIG. 10 shows a pop-up menu for naming sound recordings accordance with the invention;

FIG. 11 shows a pop-up menu used for managing folders in accordance with the invention; and

FIG. 12 shows a pop-up menu used for managing sound recordings in accordance with the invention.

### DETAILED DESCRIPTION OF THE PREFERRED EMBODIMENTS

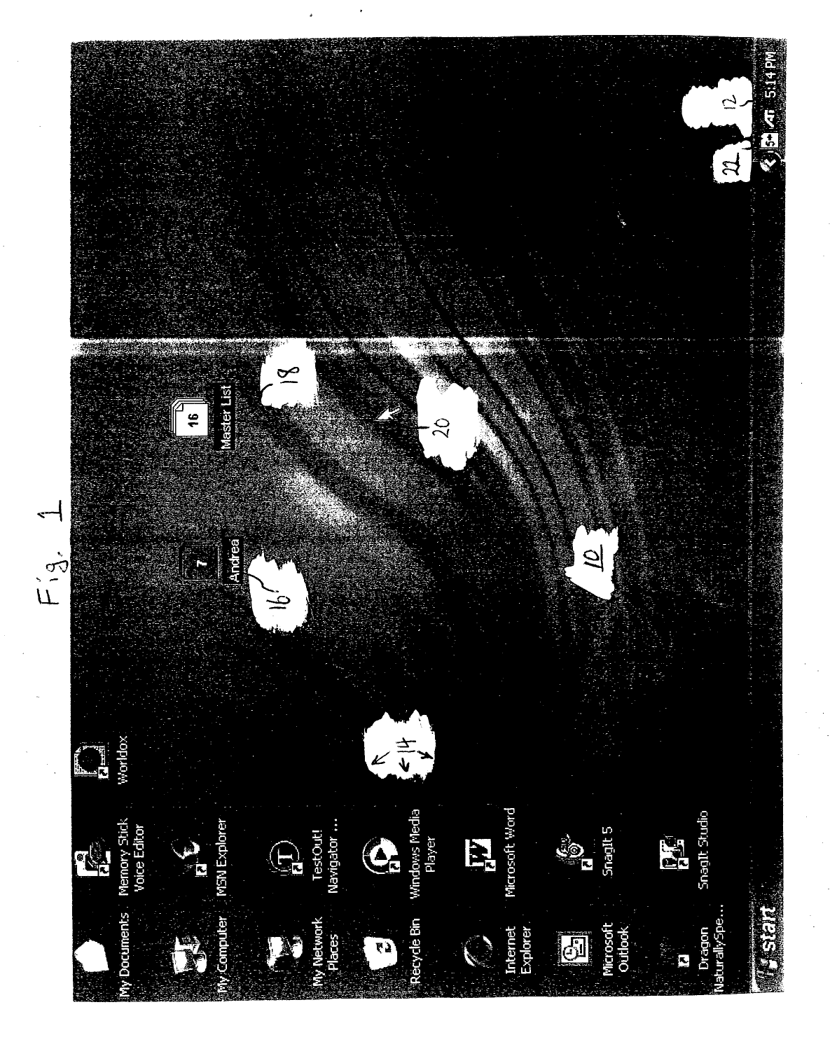

FIG. 1 shows a screen shot of the Microsoft, Windows XP desktop in accordance with one embodiment of the invention. The desktop display includes a main display area 10, a tool tray 12, a multiple of icons 14, a voice-in-note icon 16 (labeled “Andrea”), a voice-in-note master list icon 18 (labeled “Master List”) and a mouse pointer 20. One of the icons in the tool tray is a voice-in-note tool tray icon 22. It should be noted that the software of the present invention is generally referred to as the “voice-in-note program” or “voice-in-note software.” It should be further noted that the sound recordings generated and handled by the software will alternatively be referred to as “notes.”

In the depicted implementation, the voice-in-note master list icon 18 and tool tray icon 22 are created upon installation of the voice-in-note software. The “Andrea” icon 16 is a custom icon created by a user for purposes of designating a sub-group of sound recordings.

In the FIG. 1 embodiment, a user makes a sound recording by clicking on any one of the voice-in-note icons (16, 18 or 22). That is, the user moves the mouse such that the mouse pointer is positioned over one of the voice-in-note icon 16, voice-in-note master list icon 18 or voice-in-note tool tray icon 22 and then presses the left mouse button. Recording begins upon movement of the mouse button down from its resting position and terminates upon return of the mouse button to its resting position. Preferably, the sound that is recorded is the sound picked up by a microphone connected to the computer.

In the FIG. 1 embodiment, each of the voice-in-note, voice-in-note master list and voice-in-note tool tray icons has a “hot spot” area located generally in the center of the icon. The mouse pointer must be located within a hot spot area to initiate recording. The area outside the hot spot area but still within the area of the icon (the “edge” area) is used for grabbing and moving the icon. When the mouse pointer is in the edge area of an icon, the pointer changes to a four-way arrow as a way to visually indicate to the user that the icon may now be grabbed and moved.

The recordings made according to the invention are sequentially numbered, date stamped and time stamped. They are stored at a predetermined location, or at predetermined multiple locations, in any one of the computer's associated storage areas.

Each recording made is associated with one or more of the voice-in-note icons 16, 18 and 22. The numbers displayed within each of the voice-in-note icons 16 and 18 respectively indicate how many recordings are currently associated with the icons. Thus, in the example of FIG. 1, the “Andrea” icon has 7 associated recordings, and the “Master List” icon has 16 associated recordings. The “5+” label in the tool tray icon indicates that the tool tray icon is associated with more than 5 recordings. For 5 associated recordings or less, the number within the tool tray icon indicates the actual number of associated recordings, with the “+” indication deleted.

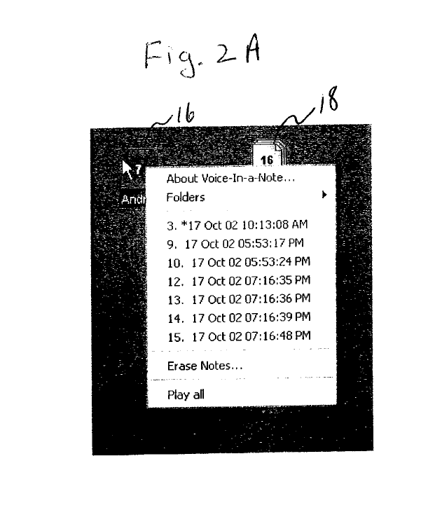

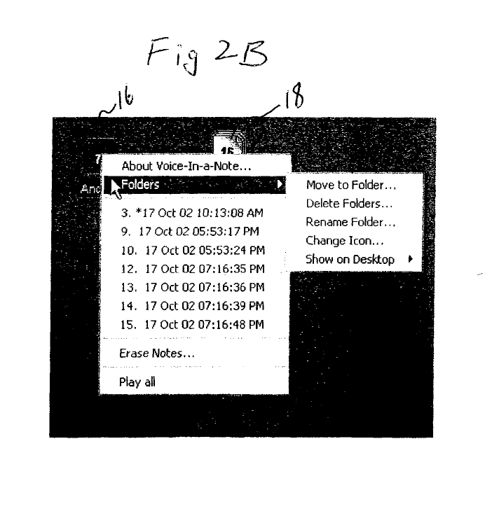

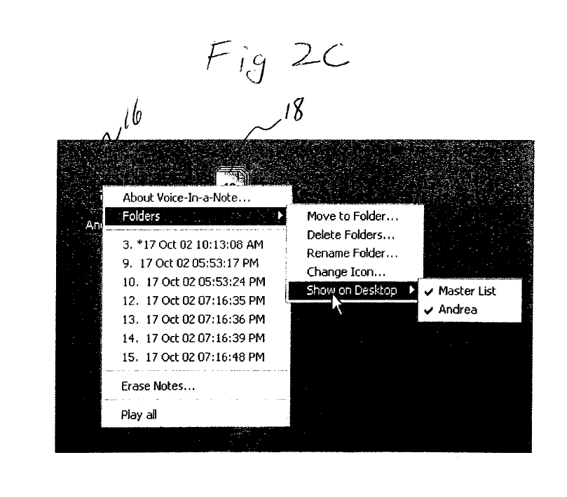

To display the recordings associated with one of the voice-in-note icons, a user “right-clicks” on that icon. That is, the user moves the mouse to position the mouse pointer on the desired voice-in-note icon and then depresses the right mouse button. FIG. 2A shows the pop-up menu that appears when the “Andrea” icon of FIG. 1 is right-clicked. As can be seen from FIG. 2A, the “Andrea” icon is associated with 7 recordings, recordings 3, 9, 10 and 12-15. All of the notes associated with the “Andrea” icon were recorded on Oct. 17, 2002, at various times between 10:13:08 am and 07:16:48 pm. Once the note listing is displayed, the user may left-click on an individual recording to play back that recording. An asterisk indicates the most recently played recording.

In addition to associated recording selections, the menu of FIG. 2A includes an “About Voice-In-a-Note” selection, an “Erase Notes” selection, a “Play All” selection and a “Folders” selection. When the “About Voice-In-a-Note” selection is left-clicked, general information about the voice-in-note program is provided. When “Erase Notes” is selected, the user is presented with options for erasing stored recordings. When “Play all” is selected, all of the recordings associated with the icon are played back in order of the earliest recording to the latest recording. When “Folders” is selected the user is presented with another pop-up menu.

Regarding the playback of all recordings associated with an icon, an alternative to the “Play all” selection is provided. More particularly, as an alternative to using the “Play all selection of FIG. 2B, a user may initiate playback of all recordings associated with an icon by moving the mouse pointer to the icon's hot spot and then “fast-clicking” with the left mouse button. When the hot spot of the tool tray icon is fast-clicked, all notes from all folders are played chronologically in order of recording. Pseudocode showing the processing steps for the one-click recording and one-click playback features of the first embodiment is attached as Appendix I.

Regarding the “Folders” selection, FIG. 2B shows the pop-up menu that appears when “Folders” is selected from the menu of FIG. 2A. As can be seen from FIG. 2B, the menu associated with “Folders” offers the following options: “Move to Folder,” “Delete Folders;” “Rename Folder;” “Change Icon;” and “Show on Desktop.” When “Move to Folder” is selected, options for moving one or more notes to another folder are presented (the terms “folder” and “icon” are interchangeably used herein). When “Delete Folders” is selected, options for deleting one or more folders is presented. When “Rename Folder” is selected, the user may specify a new name for the current folder. When “Change Icon” is selected, the user may specify a different color for the current icon, facilitating the use of color to designate types of notes. When “Show on Desktop” is selected, a third pop-up menu appears as shown in FIG. 2C. The third pop-up menu allows the user to specify which voice-in-note icons, other than the tool tray icon, are to be displayed. Check marks indicate the icons selected for display. The tool tray icon is always displayed.

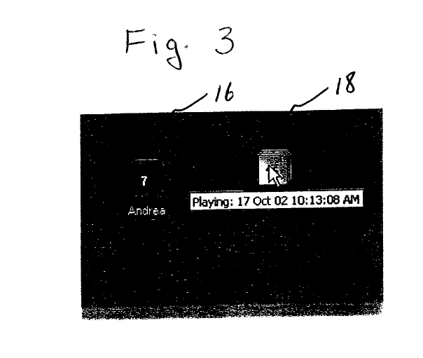

In any event, whenever a recording is being played back, a notifying message is provided on the display. FIG. 3 shows an example in which recording number 17 is being played back from the voice-in-note master list folder. As can be seen, the notifying message appears in close proximity to the folder/icon from which playback was designated.

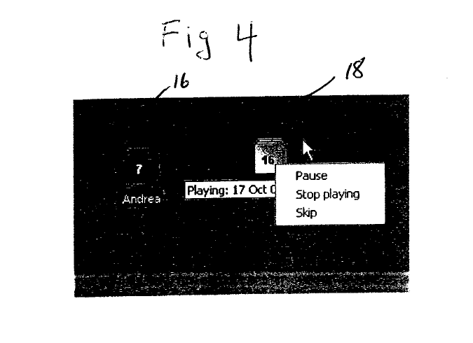

If any icon from which playback was designated is right-clicked during playback, a playback options pop-up menu is displayed. FIG. 4 shows a preferable playback options pop-up menu. As can be seen from FIG. 4, the menu includes “Pause,” “Stop playing,” and “Skip” selections. When “Stop playing” is selected, playback of the presently playing recording is stopped. When “Skip” is selected, playback of the presently playing recording is stopped and playback of the next recording associated with the icon is immediately started. When “Pause” is selected, playback of the presently playing recording is stopped but may be resumed at the point of stoppage by again selecting “Pause.”

With respect to the storage of recordings, the invention provides a user with status notes when the storage limitations of the computer are being approached. In a preferable embodiment, a warning and/or a reminder to delete recordings is provided when the total amount of memory occupied by recordings exceeds 5 MB (about 2 minutes of record time in most current systems). Another warning/reminder is sent when 10 MB are occupied. The warnings/reminders appear each time the occupied memory doubles util approximately 80% of the computer's storage is occupied.

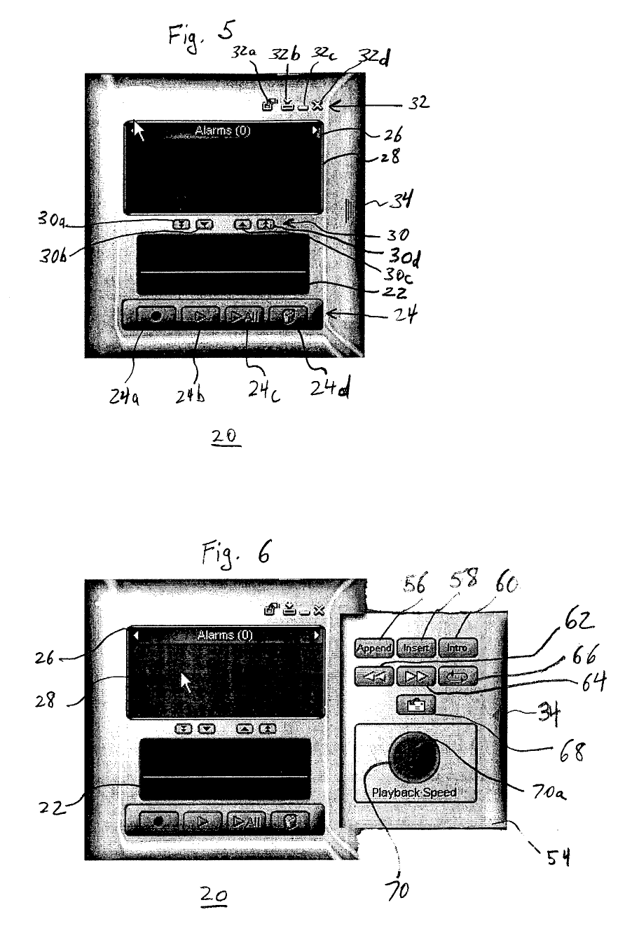

FIG. 5 shows a screen shot of a graphical user interface 20 in accordance with a second embodiment of the invention. The interface includes: a sound display area 22 for displaying mathematical representations of recorded sounds; an operations button area 24 for controlling record, playback and erase operations; a folder title area 26 for displaying the title of an accessed folder of recordings and for manipulating available folders; a note display area 28 for displaying the notes in the folder indicated in the folder title area; a notes-view control buttons area 30 having buttons for controlling the display of notes in the note display area; a settings buttons area 32 having buttons for setting selected environmental system parameters; and an expansion indicator 34 for expanding the graphical user interface to provide additional interface areas. The expanded version of the interface is shown in FIG. 6 and will be discussed in more detail below.

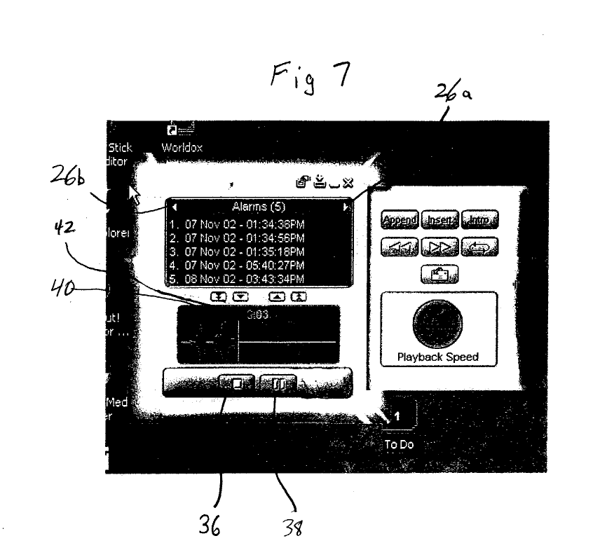

To record a sound using the interface of FIG. 5, the user left-clicks a record button 24a in the operations button area. The button may be clicked by moving the mouse pointer over the button, pressing the left mouse button to the “down” position, holding the mouse button down, and then allowing the mouse button to return to its “up” position. In this case, sound recording begins upon movement of the mouse button down from its “up” position and terminates upon return of the mouse button to its “up” position. As an alternative, the record button may be “fast-clicked,” in which case recording starts upon completion of the record button click—that is upon return of the mouse button to its up position—and continues until the user clicks a stop button 36 (shown in FIG. 7).

As in the first embodiment, the second embodiment includes a program symbol in the operating system tool tray/system tray, and sound recordings can be made in response to a single mouse click on the symbol. That is, the user can generate a recording by positioning the mouse pointer over the symbol, pressing and holding the left mouse button to record, and releasing the button to stop recording. In a preferred implementation, the completed recording is automatically stored without any further operation by the user.

FIG. 7 shows the graphical user interface as it appears during sound recording. The interface is superimposed on a typical Microsoft Windows desktop. As can be seen from FIG. 7, a sliding indication line 40 is provided in the sound display area for indicating the current time relative to the recording start time. Also an elapsed-time clock 42 is provided for numerically indicating the time from recording start in “minutes:seconds” format. The operations button area is modified to include the stop button 36 and a pause button 38. The pause button is pressed when a user desires to stop a recording at a desired point and then resume recording at that same point at a later time. The “pause” function differs from the “stop” function in that it doesn't indicate the end of a note, but rather indicates the temporary interruption of a note. It should be noted that the operations button area is not modified in the case wherein recording is started when the mouse button is moved down from its up position and is stopped upon return of the mouse to it's up position.

In FIG. 7 the folder “Alarms” contains five notes. The number of notes in the folder is indicated in parenthesis next to the folder title, and the notes are listed chronologically in the notes display area. In the event a folder has more notes than can be displayed at one time in the notes display area, the user can scroll through the complete list of notes by using buttons 30a-30d (see FIG. 5). The scroll buttons have the following functions: button 30a allows the user to scroll down a “page” at a time (e.g. to view notes 6 through 10); button 30b allows the user to scroll down a note at a time; button 30c allows the user to scroll up a note at a time, and button 30d allows the user to scroll up a page at a time. Furthermore, available folders can be sequentially viewed by using buttons 26a and 26b, button 26a providing a forward sequential scroll and button 26b providing a reverse sequential scroll.

Referring back to FIG. 5, when the user wishes to play a note from a folder, the user selects the note from the notes display area by left-clicking it and then presses a play button 24b. The selected note is then played as it's waveform is displayed in the sound display area with the sliding indication line showing progression through the note. To play a sequence of notes, the user highlights them using the left-mouse button and then presses button 24b. The highlighted notes are then played back in sequence.

An “All Play” button 24c is provided in the event the user would like to sequentially playback all notes in a selected folder without having to select them with the mouse.

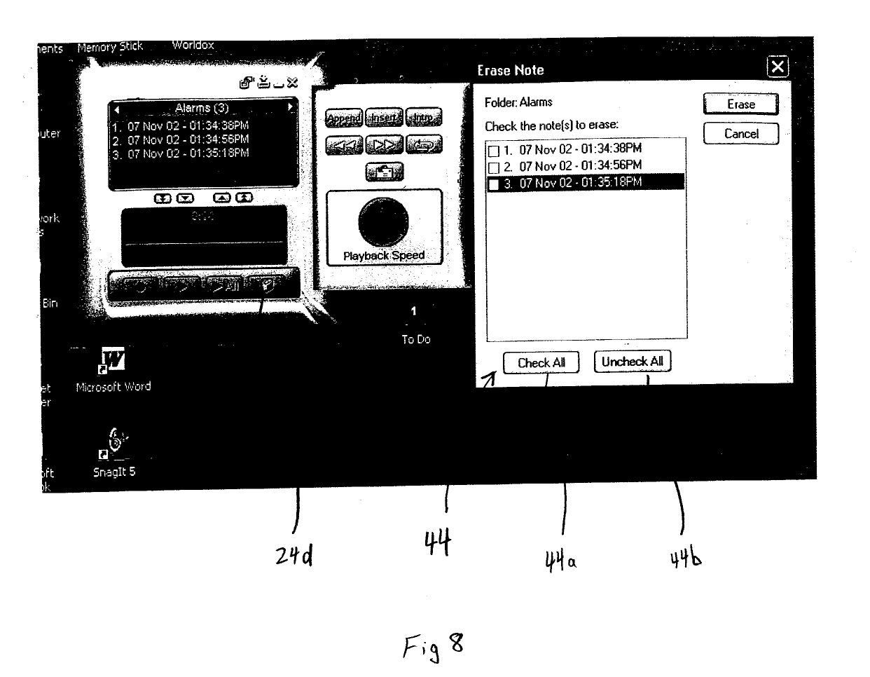

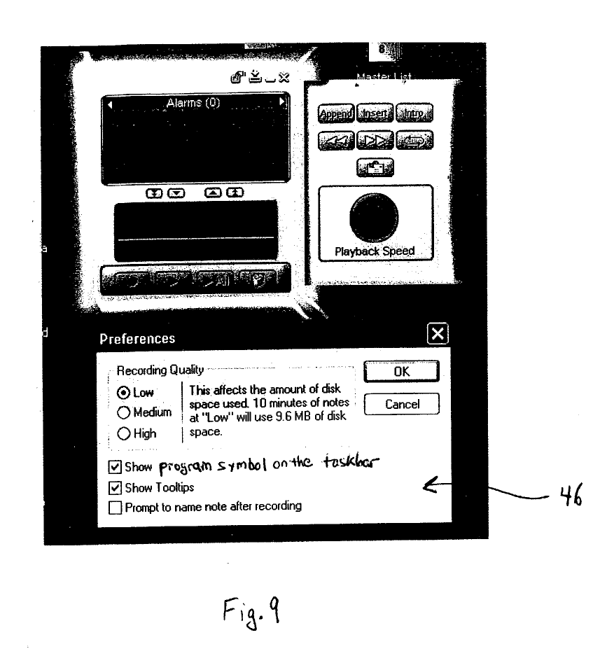

An erase button 24d is provided for erasing notes. When the erase button is left-clicked a pop-up menu appears that allows the user to specify which notes are to be erased. The erase pop-up menu is shown in FIG. 8 and is indicated by reference numeral 44. As can be seen from FIG. 8, button 44a allows the user to “Check All” notes and button 44b allows the user “Uncheck All” notes.

Regarding, buttons 32a-32d of the settings buttons area 32, button 32d closes the graphical user interface, button 32c minimizes the interface. Button 32b provides a reduced format view of the interface, and button 32a provides a pop-up menu for setting system preferences. Each is activated by left-clicking.

The pop-up menu corresponding to button 32a is shown in FIG. 9 and is indicated by reference numeral 46. The menu is entitled Preferences. It allows the user to select the desired recording quality, low, medium or high; and it allows the user to select whether or not the program symbol should be shown on the desktop taskbar, whether or not tooltips should be shown, and whether or not the system should prompt for a name each time a note is recorded.

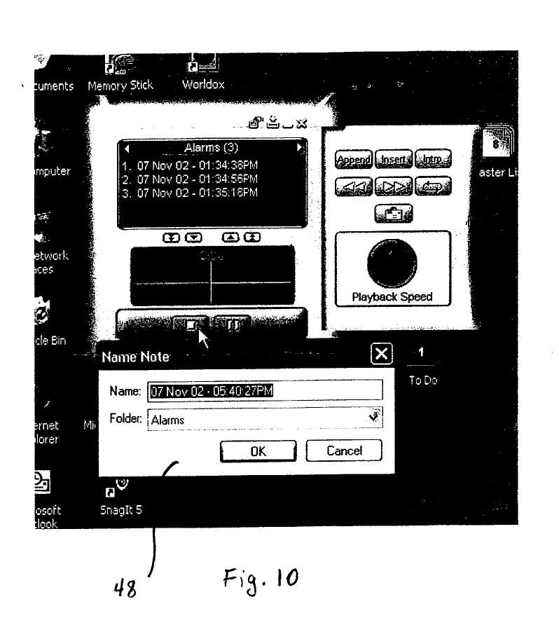

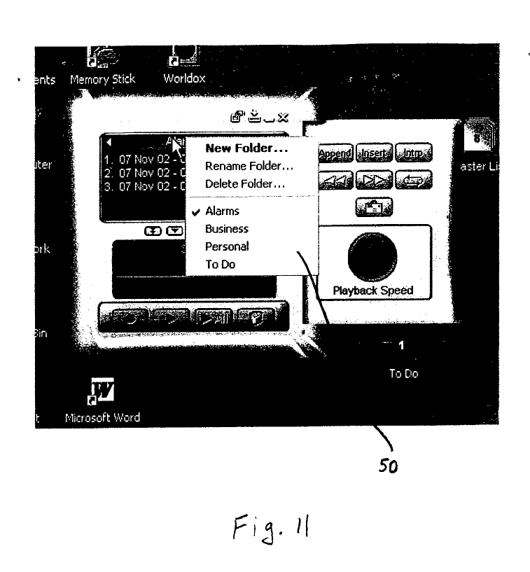

When the “prompt to name” feature is enabled, a pop up menu appears each time a recording is completed. The menu is shown in FIG. 10. It is entitled “Name Note” and is denoted by reference numeral 48. The Name Note menu allows the user to specify a name for a just-recorded note and to specify a folder to which the note is saved. As shown in FIG. 10, a default name in the date-time format is provided upon display of the menu.

Other pop-up menus appear when the user right-clicks the folder display area and when the user right-clicks an individual note.

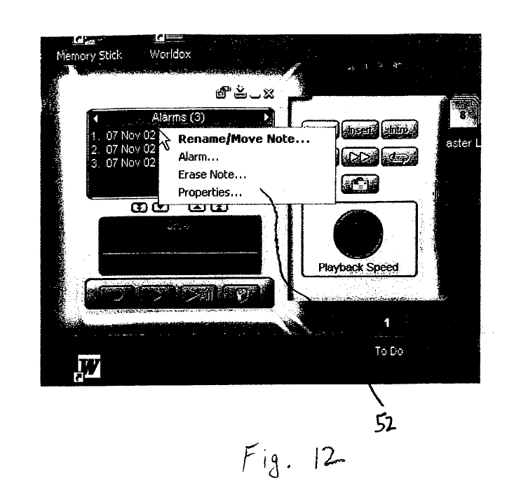

The pop-up menu that appears upon right-clicking the folder display area is shown in FIG. 11 and is denoted by reference numeral 50. As can be seen in FIG. 11, the user can use the menu to switch between existing folders (“Alarms,” “Business,” “Personal” and “To Do” in the illustrative example), rename an existing folder, delete an existing folder, and create a new folder.

The pop up menu that appears when the user right-clicks a note is shown in FIG. 12. As can be seen from FIG. 12, the user can use the menu to rename the note, move the note to another folder, use the note as an alarm, erase the note, and view properties of the note. Regarding the alarm feature, the user can set the note to automatically play at a predetermined time in the future. Furthermore, several alarm options exist, such as setting a note to play daily or weekly. The numerous options are presented in another pop-up menu (not shown). Regarding the properties feature, the user selects the properties menu option to view information about the note, such as its date of creation and quality.

Next, referring back to FIG. 6, the expanded format graphical user interface will be discussed in more detail. As can be seen from FIG. 6, the expanded format interface includes an expansion section 54. The expansion section includes several buttons 56-66 and a dial 70 for playback and editing of notes, and a button 68 for e-mailing notes.

Button 56 allows a user to append additional recorded sound to an existing note. The user merely selects the existing note and then clicks the append button to begin recording. Upon clicking a stop button displayed in operations button area 24, the newly recorded sound is appended to the selected note.

Button 58 allows the user to insert additional recorded sound in to an existing note. The insert operation functions in the same manner as the append operation, with the exception that newly recorded sound is inserted into the selected note at a user designated position, and not necessarily at the end of the selected note. More specifically, the user designates the insertion point of the newly recorded sound by moving the mouse pointer within the sound display area until the pointer is located at the position corresponding to the desired insertion point and then clicking.

Button 60 allows for a quick perusal of stored notes. Selecting this button initiates playback of the first three seconds of each note in a selected folder. That is, the first three seconds of the first note is played and is automatically followed by playback of the first three seconds of the next note, and so on. In addition, upon invoking of the “intro” function, the operations button display area displays a “skip” button, so that the user can skip to the next note prior to the automatic skip that occurs after three seconds.

Button 62 provides a fast reverse playback function. The user presses and “holds” this button, using the left mouse button, to initiate a fast reverse play of a currently playing note. The fast reverse play will continue until the user “releases” the button. When the button is released, playback continues at normal speed from the point where fast reverse playback was terminated.

Button 64 operates in the same manner as button 62 but provides for fast forward playback rather than fast reverse playback.

Button 66 initiates “looped” playback of a selected note. That is, the selected note will play repeatedly until a stop button displayed in the operations button area is selected.

Button 68 allows the user to e-mail a previously recorded note to a desired recipient. The user selects a note to be e-mailed then clicks the button. Upon clicking, the user is presented with an e-mail template having the selected note as an attachment. Preferably, the attached note is in the “wav” format.

Dial 70 allows for adjustment of playback speed along a continuous scale. The dial includes a circular indicator 70a for showing its current setting. In a preferred embodiment, the indicator in the 0 degree position indicates normal playback speed. Turning the dial counterclockwise sets the playback speed progressively lower than normal playback speed, while turning the dial clockwise sets the playback speed progressively higher than normal playback speed.

Having described the overall system and method of the invention, several implementation specific embodiments will now be described in detail.

One such embodiment includes a speech recognition program such as Via Voice. Such programs can receive “wav” files as input and convert the wav files to text. Thus, a user can create a sound recording of, for example, an office memorandum, and have the recording passed to the Via Voice program for conversion to text. The text memorandum could then be circulated as a paper memorandum or as an e-mail. In any event, it should be noted that the sound recording of the memo may be originally generated in the wav format, or may be generated in another format and converted to the wav format prior to transmission to the Via Voice program.

Another embodiment includes a billing program such as ProLaw. Such programs are commonly used by attorneys for keeping track of the time spent on various cases. The sound recording of the present invention is combined with speech recognition software to provide for efficient generation of billing program entries. More particularly, entries may be dictated using the recording of the invention and then converted to text prior to passing them to the billing program. Using the sound recording of the present invention to generate billing program entries makes generation of the entries easier since the entries do not have to be made by hand. Accordingly, users are less likely to delay the generation of entries and entries are less likely to be lost or forgotten. In a preferred embodiment, the time entries are recorded as a note in the form of a wav file and the wav file is automatically converted to a text file upon importation to the billing program.

In any of the above discussed embodiments, effectiveness may be enhanced by combining the invention with the invention of U.S. Pat. No. 6,363,345, which is hereby incorporated by reference. One skilled in the art will readily understand how to combine the present invention with that of U.S. Pat. No. 6,363,345 when the patent is read in view of this disclosure.

While the present invention has been particularly shown and described in conjunction with preferred embodiments thereof, it will be readily appreciated by those of ordinary skill in the art that various changes may be made without departing from the spirit and scope of the invention. For example, it is possible to provide a sound-activated recording mode in accordance with the invention. In such a mode, recording is performed only when the system microphone is detecting a sound and not carried out when the system perceives only silence.

Furthermore, while the invention has been described in the context of recording sound, it can readily be applied to the recording of video.

Still further, while the invention has been described as functioning in a Microsoft Windows Operating System environment, it could function in other environments, such as the Macintosh Operating System environment.

Accordingly, it is intended that the appended claims be interpreted as including the embodiments described herein as well as all equivalents thereto.

[image]

What is claimed is:

1. A method for generating recordings on a computer, comprising the steps of:
initiating recording in response to the depression of a button associated with said computer; and
terminating recording in response to release of said button;
such that a recording is generated by a single button-push operation and said recording is automatically stored in a predetermined location within said computer.

2. A method as claimed in claim 1, wherein said button is a button of a computer mouse.

3. A method as claimed in claim 1, wherein said button is a key on a computer keyboard.

4. Computer program product, characterized by computer program means adapted to perform the method steps defined in claim 1.

5. A computer program product as claimed in claim 4, wherein said step of initiating recording includes moving a pointer associated with a computer mouse to a display screen icon and then pressing a button of said computer mouse.

6. A computer program product as claimed in claim 4, wherein said step of initiating recording includes moving a pointer associated with a computer mouse to an operations button area of a graphical user interface and then pressing a button of said computer mouse.

7. A method as claimed in claim 1, wherein said steps of initiating recording and terminating recording respectively include initiating sound recording and terminating sound recording.

8. A method for generating recordings on a computer, comprising the steps of:
initiating recording in response to the depression of a button associated with said computer; and
terminating recording in response to a second depression of said button;
such that a recording is generated by two button-push operations and said recording is automatically stored in a predetermined location within said computer.

9. A method as claimed in claim 8, wherein said button is a button of a computer mouse.

10. A method as claimed in claim 8, wherein said button is a key on a computer keyboard.

11. Computer program product, characterized by computer program means adapted to perform the method steps defined in claim 8.

12. A computer program product as claimed in claim 11, wherein said step of initiating recording includes moving a pointer associated with a computer mouse to an operations button area of a graphical user interface and then pressing a button of said computer mouse.

13. A method as claimed in claim 8, wherein said steps of initiating recording and terminating recording respectively include initiating sound recording and terminating sound recording.

14. A computer system for generating recordings, comprising:
generating means for generating a signal to be recorded; and
a button;
whereby recording of at least a portion of said signal is initiated upon depression of said button and terminated upon release of said button, such that a recording is generated by a single button-push operation and said recording is automatically stored in a predetermined location within said computer system.

15. A computer system as claimed in claim 14, wherein said button is a computer mouse button.

16. A computer system as claimed in claim 14, wherein said button is a key on a keyboard of said computer system.

17. A computer system as claimed in claim 14, wherein said generating means is a microphone.

18. A computer system as claimed in claim 14, wherein said predetermined location is a predetermined location on a hard disk drive of said computer system.

19. A computer system as claimed in claim 14, wherein said predetermined location is a predetermined location on an optical disk drive of said computer system.

20. A computer system as claimed in claim 14, further comprising a display for displaying a mathematical representation of said recording.
